(19) United States
(12) Patent Application Publication
(10) Pub. No.: US 2020/0134531 A1
(43) Pub. Date: Apr. 30, 2020

(54) METHOD AND SYSTEM FOR PREDICTING OCCUPANCY OF A FACILITY

(71) Applicant: Ruptub Solutions Private Limited, Bengaluru (IN)

(72) Inventors: Abhishek TIWARI, Nagpur (IN); Chaitanya SANGANI, Kakinada (IN); Jasjot Singh MAAN, Mohali (IN); Raghotham SRIPADRAJ, Bangalore (IN)

(73) Assignee: Ruptub Solutions Private Limited, Bengaluru (IN)

(21) Appl. No.: 16/399,886

(22) Filed: Apr. 30, 2019

(30) Foreign Application Priority Data
Oct. 30, 2018 (IN) 201841040974

(51) Int. Cl. G06Q 10/06; G06Q 10/04; G06Q 10/02

(52) U.S. Cl. CPC G06Q 10/06315; G06Q 50/12; G06Q 10/02; G06Q 10/04

(57) ABSTRACT

The present disclosure provides a system to predict the occupancy of a facility. The system executes instructions to causes one or more processors to perform a method. The method includes a first step of collecting a first set of data associated with the occupancy of the facility in past. In addition, the method includes a second step of receiving a second set of data associated with the occupancy of the facility in a plurality of past seasons. Further, the method includes a third step of obtaining a third set of data associated with the demand of one or more users for the rooms of the facility. Furthermore, the method includes a fourth step of predicting the occupancy of the facility after applying machine learning algorithms over the first set of data, the second set of data and the third set of data.

### TECHNICAL FIELD

The present disclosure relates to a field of facility management system. More particular, the present disclosure relates to method and system for predicting occupancy of a facility.

### INTRODUCTION

Service industry has taken a major leap with the huge increase in a number of people constantly travelling from one place to another. People are in constant need for a place to stay overnight or for a few days. Typically, people stay in various hotels which match their needs and comfort ability factor. The continuous stay of multiple peoples in multiple rooms of the hotels makes it a hassle to do maintenance work or renovation work of the hotel. The occupancy of the hotels needs to be predicted to choose a suitable period for performing maintenance and renovation work. This has led to a demand for an occupancy predicting system for predicting the occupancy of the hotels to perform multiple task related to the maintenance of the hotels.

### SUMMARY

In a first example, a computer-implemented method is provided. The computer-implemented method for predicting the occupancy of a facility. The method includes a first step of collecting a first set of data associated with the occupancy of the facility in past. In addition, the method includes a second step of receiving a second set of data associated with the occupancy of the facility in a plurality of past seasons. Further, the method includes a third step of obtaining a third set of data associated with the demand of one or more users for the rooms of the facility. Furthermore, the method includes a fourth step of predicting the occupancy of the facility after applying machine learning algorithms over the first set of data, the second set of data and the third set of data. The first set of data, the second set of data and the third set of data are collected from a plurality of sources. The third set of data corresponds to a clickstream data. The occupancy of the facility is predicted in real-time for a particular time interval.

In an embodiment of the present disclosure, the method includes a fifth step of gathering a fourth set of data associated with the scheduled events in the nearby areas to the facility. In addition, the method includes a sixth step of gathering a fifth set of data associated with nearby facility competitors. Further, the method includes a seventh step of gathering a sixth set of data associated with the feedback of the one or more users. Furthermore, the method includes an eighth step of gathering a seventh set of data associated with the booking of the facility through coupons and offers. The fourth set of data, the fifth set of data, the sixth set of data and the seventh set of data are analyzed through the machine learning algorithms to predict the occupancy of the facility.

In an embodiment of the present disclosure, the first set of data includes past booking data, past occupancy data and the past booking details of the one or more users.

In an embodiment of the present disclosure, the second set of data includes booking data received during summers, winters, vacations, weekends, festivals, rainy season.

In an embodiment of the present disclosure, the plurality of sources includes one or more web-based platforms associated with the facility, one or more websites associated with the facility, one or more applications associated with the facility and stored past booking database associated with the facility.

In an embodiment of the present disclosure, the particular time interval includes specific days, specific date, specific time, weeks, months, years and specific festivals. The occupancy of the facility at the particular time interval is predicted after a request for the prediction is sent to an administrator.

In an embodiment of the present disclosure, the method includes a ninth step of updating the first set of data, the second set of data and the third set of data. The updating is done in real time.

In a second example, a computer system is provided. The computer system includes one or more processors and a memory. The memory is coupled to the one or more processors. The memory stores instructions. The instructions are executed by the one or more processors. The execution of the instructions causes the one or more processors to perform a method for predicting the occupancy of a facility. The method includes a first step of collecting a first set of data associated with the occupancy of the facility in past. In addition, the method includes a second step of receiving a second set of data associated with the occupancy of the facility in a plurality of past seasons. Further, the method includes a third step of obtaining a third set of data associated with the demand of one or more users for the rooms of the facility. Furthermore, the method includes a fourth step of predicting the occupancy of the facility after applying machine learning algorithms over the first set of data, the second set of data and the third set of data. The first set of data, the second set of data and the third set of data are collected from a plurality of sources. The third set of data corresponds to a clickstream data. The occupancy of the facility is predicted in real-time for a particular time interval.

In a third example, a non-transitory computer-readable storage medium is provided. The non-transitory computer-readable storage medium encodes computer executable instructions that, when executed by at least one processor, performs a method for predicting the occupancy of a facility. The method includes a first step of collecting a first set of data associated with the occupancy of the facility in past. In addition, the method includes a second step of receiving a second set of data associated with the occupancy of the facility in a plurality of past seasons. Further, the method includes a third step of obtaining a third set of data associated with the demand of one or more users for the rooms of the facility. Furthermore, the method includes a fourth step of predicting the occupancy of the facility after applying machine learning algorithms over the first set of data, the second set of data and the third set of data. The first set of data, the second set of data and the third set of data are collected from a plurality of sources. The third set of data corresponds to a clickstream data. The occupancy of the facility is predicted in real-time for a particular time interval.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of a facility, in accordance with various embodiments of the present disclosure;

FIG. 2 illustrates an interactive computing environment for enabling real-time prediction of occupancy of the facility, in accordance with various embodiments of the present disclosure;

FIG. 3 illustrates a flowchart for predicting the occupancy of the facility, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

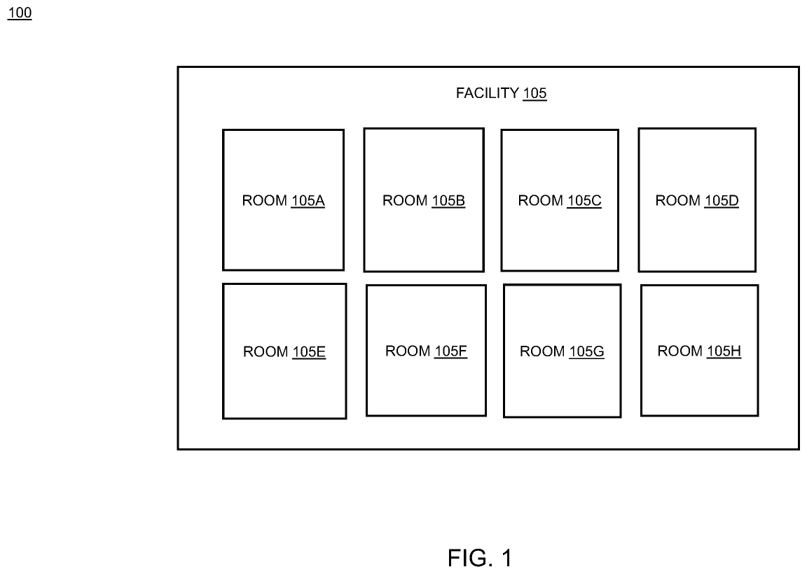

FIG. 1 illustrates a block diagram 100 of a facility 105, in accordance with various embodiments of the present disclosure. In an embodiment of the present disclosure, the facility 105 is any building or place used for a particular purpose. In addition, the facility 105 is any place used to provide a particular service. Further, the facility 105 is a place used for residential purpose. In an example, the facility 105 is any commercial and residential unit used for residence purposes. In an embodiment of the present disclosure, the facility 105 includes a plurality of rooms 105a-105h. Each of the plurality of rooms 105a-105h is utilized for the stay of users.

In an example, each room of the plurality of rooms 105a-105h is similar in structure and facilities compared to other rooms of the plurality of rooms 105a-105h. In addition, cost of each room of the plurality of rooms 105a-105h is similar to the cost of other rooms. Further, the plurality of rooms 105a-105h is of same type and category. In an embodiment of the present disclosure, each room of the plurality of rooms 105a-105h is for the stay of maximum two users. In another embodiment of the present disclosure, each room of the plurality of rooms 105a-105h is for the stay of maximum three users. In yet another embodiment of the present disclosure, each room of the plurality of rooms 105a-105h is for the stay of any suitable number of users. In an embodiment of the present disclosure, each room of the plurality of rooms 105a-105h includes a bedroom, a bathroom and a balcony. In another embodiment of the present disclosure, each room of the plurality of rooms 105a-105h may include any other region. In an example, the facilities inside each room of the plurality of rooms 105a-105h include but may not be limited to a television, a geyser, AC, fridge, any indoor game, food delivery option through a call, message or application and Wi-Fi.

In another example, each room of the plurality of rooms 105a-105h is different in the structure and facilities compared to other rooms of the plurality of rooms 105a-105h. In addition, the cost of each room of the plurality of rooms 105a-105h is different from the cost of other rooms based on the structure and facilities. In an example, a room 105a, a room 105b and a room 105e are super deluxe rooms which are equipped with high-grade facilities. Further, a room 105c, a room 105g and a room 105h are deluxe rooms which include a lesser number of facilities than the facilities offered by the super deluxe rooms. Also, the cost of the deluxe rooms is less than the cost of the super deluxe rooms. In addition, one or more users 205 book the plurality of rooms 105a-105h based on the requirement and preference of the facilities and services.

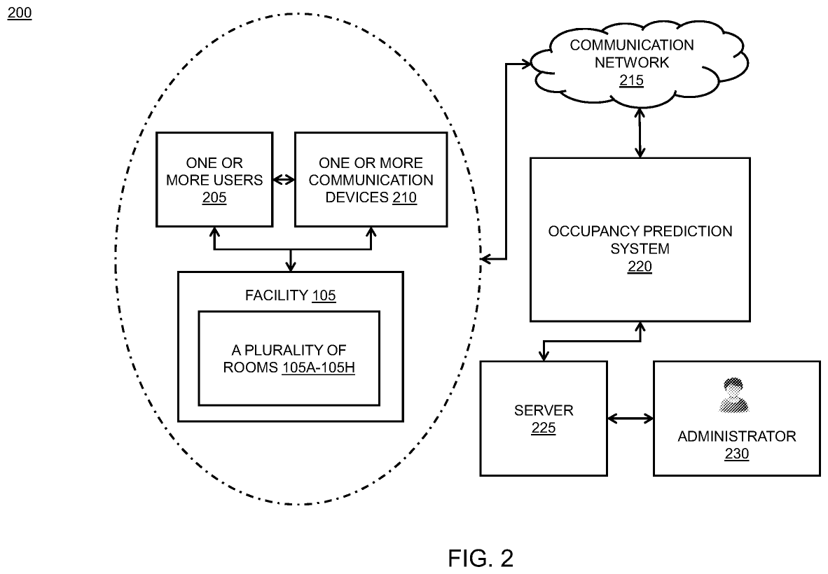

FIG. 2 illustrates a block diagram 200 of an interactive computing environment for predicting the occupancy of the facility 105 in real time, in accordance with various embodiments of the present disclosure. The prediction of the occupancy of the facility 105 is done for one or more purposes. The one or more purposes include renovation of the facility 105, maintenance work of the facility 105, management of the facility 105, increasing or decreasing number of offers on the booking of the facility 105 based on the occupancy of the facility 105. The block diagram 200 includes the facility 105, the plurality of rooms 105a-105h, the one or more users 205, one or more communication devices 210, a communication network 215, an occupancy prediction system 220, a server 225 and an administrator 230.

In an embodiment of the present disclosure, the facility 105 is any building or a place used for the residential purpose. In an example, the facility 105 is a hotel. The facility 105 includes the plurality of rooms 105a-105h. The plurality of rooms 105a-105h is for the stay of the one or more users 205. The one or more users 205 are associated with the facility 105. The one or more users 205 do stay at the facility 105 for a specific time interval. Each of the one or more users 205 is a person or individual who looks for a place to stay overnight or for a few days. Each of the one or more users 205 books the room of the facility 105 for a particular purpose. In an example, the purpose may include to enjoy vacations, to attend a meeting or to meet with a client. In an embodiment of the present disclosure, the one or more users 205 use a corresponding communication device of the one or more communication devices 210 to book the room of the facility 105. In an embodiment of the present disclosure, the one or more users 205 book the room of the facility 105 through website of the facility 105. Each of the one or more users 205 access the website of the facility 105 through the corresponding communication device of the one or more communication devices 210. In another embodiment of the present disclosure, the one or more users 205 book the room of the facility 105 through one or more facility booking platforms. Each of the one or more users 205 accesses the one or more facility booking platforms through the corresponding communication device of the one or more communication devices 210. In an embodiment of the present disclosure, the one or more users 205 are the users who booked the room of the facility 105 in past.

In an embodiment of the present disclosure, the one or more communication devices 210 facilitate access to the one or more facility booking platforms. The one or more users 205 are associated with the one or more communication devices 210. In an example, the one or more communication devices 210 include but may not be limited to a smartphone, a tablet, a laptop, a desktop and an electronic wearable device. In an example, each of the one or more users 205 accesses the communication device in real time. In an embodiment of the present disclosure, each of the one or more communication devices 210 is a portable communication device. The one or more communication devices 210 include an application associated with the facility 105 for the booking of the rooms of the facility 105. Further, the one or more communication devices 210 are associated with a specific type of operating system. The specific type of operating system includes but may not be limited to an Android operating system, a Windows operating system, a mac operating system and the like. Furthermore, the one or more communication devices 210 are connected to internet through the communication network 215. In an embodiment of the present disclosure, the communication network 215 enables the one or more communication devices 210 to book the room through the applications or websites. In addition, the communication network 215 enables the occupancy prediction system 220 to gain access to the internet for transmitting data to the server 225. Moreover, the communication network 215 provides a medium to transfer the data between the one or more communication devices 210 and the occupancy prediction system 220. Further, the communication network 215 provides the medium to transfer the data between the occupancy prediction system 220 and the server 225. Further, the medium for communication may be infrared, microwave, radio frequency (RF) and the like.

The facility 105 is associated with the occupancy prediction system 220 to predict the occupancy of the facility 105. The occupancy prediction system 220 collects a first set of data associated with the occupancy of the facility 105 in past. In addition, the first set of data is collected from a plurality of sources. The plurality of sources includes stored booking database associated with the facility 105, one or more online web-based platforms associated with the facility 105, one or more websites associated with the facility 105 and the one or more facility booking platforms. The first set of data includes past booking data, past occupancy data and booking details of the one or more users 205. The first set of data is collected in past during the booking of rooms of the facility 105. In addition, the first set of data includes the data asked to the one or more users 205 for the booking of the facility 105. In an embodiment of the present disclosure, the first set of data is automatically stored in the server 225. In another embodiment of the present disclosure, the first set of data is manually stored in the server 225 by one or more entities associated with the facility 105. In an example, the entity is a caretaker or receptionist of the facility 105.

In an example, the one or more users 205 book a room of the facility 105 through the website associated with the facility 105. Thus, the first set of data is collected through the website. In another example, the one or more users 205 book a room of the facility 105 using a mobile application associated with the booking of the facility 105. Thus, the first set of data is collected through the mobile application associated with the facility 105. In yet another example, the one or more users 205 book a room of the facility 105 at the facility 105 only. Thus, the first set of data is collected through the details provided by the one or more users 205 at the reception of the facility 105 for the booking of one or more rooms.

The occupancy prediction system 220 receives a second set of data associated with the occupancy of the facility 105 in a plurality of past seasons. The second set of data is received from the plurality of sources. In an embodiment of the present disclosure, the second set of data includes booking data during summers, winters, vacations, weekends, festivals, rainy season. In another embodiment of the present disclosure, the second set of data includes data received during the plurality of past seasons. In an example, the occupancy prediction system 220 has the data through which the occupancy prediction system 220 determines that the occupancy of the facility 105 is high during the Christmas festival or rainy seasons.

The occupancy prediction system 220 obtains a third set of data associated with the demand of the one or more users 205 for the rooms of the facility 105. The third set of data includes a demand signal data. The demand signal data corresponds to a clickstream data. In general, the clickstream data is the record of a user's actions on the internet. Further, the clickstream data identifies the details of the user like where the user goes and what they do, from search engine searches to websites visited, conversions made, and purchases carried out. The third set of data is obtained from the plurality of sources. The plurality of sources includes the one or more websites, one or more applications, one or more web-based platforms and one or more facility booking platforms used for the booking of the room in the facility 105. In an example, each user of the one or more users 205 search for the room in the facility 105 through the one or more websites associated with the booking of the facility 105. The occupancy prediction system 220 obtains the data associated with the pages the website visitor visits. In an example, the occupancy prediction system 220 obtains the third set of data associated with the activities of the one or more users 205 on the website of the facility 105.

The occupancy prediction system 220 gathers a fourth set of data associated with the scheduled events in the nearby areas to the facility 105. In an embodiment of the present disclosure, the scheduled event includes but may not be limited to a cricket tournament, a football tournament, a job fair, a magic show, any stage performance, singing performance, and dance performance. In another embodiment of the present disclosure, the scheduled events may include any such events that are organized to attract crowd of the users at the event.

The occupancy prediction system 220 gathers a fifth set of data associated with nearby facility competitors. The fifth set of data includes the data of one or more nearby facilities. In addition, the fifth set of data includes the data associated with the facilities provided in the one or more nearby facilities, the location of the one or more nearby facilities and the price of rooms in the one or more nearby facilities.

The occupancy prediction system 220 gathers a sixth set of data associated with the feedback of the one or more users 205. The sixth set of data corresponds to satisfaction level of the one or more users 205 related to the services and facilities offered in the facility 105. In an example, a user X books a room Y of the facility 105. The user X provides a feedback regarding the facilities and services provided to the user X at the facility 105. In addition, the feedback is related to the experience of the one or more users 205 in the room Y of the facility 105.

The occupancy prediction system 220 gathers a seventh set of data associated with the booking of the facility 105 through coupons and offers. The seventh set of data includes the booking data through one or more coupons, offers and promo codes. In an example, the user A books the room of the facility 105 through a coupon which provides a 40% discount on the actual booking price of the room of the facility 105 to the user A.

The occupancy prediction system 220 predicts the occupancy of the facility 105 based on the first set of data, the second set of data, the third set of data, the fourth set of data, the fifth set of data, the sixth set of data and the seventh set of data. The occupancy prediction system 220 identifies the pattern of occupancy by using machine learning algorithms over the first set of data, the second set of data, the third set of data, the fourth set of data, the fifth set of data, the sixth set of data and the seventh set of data. In general, the machine learning explores the study and construction of algorithms that can learn from and make predictions on data. In general, algorithms are a process or set of rules to be followed in calculations or other problem-solving operations, especially by a computer. In an embodiment of the present disclosure, the machine learning algorithms are the set of rules to be followed to predict the occupancy of the facility 105 for a particular time interval. In addition, the machine learning algorithms are applied over the first set of data, the second set of data, the third set of data, the fourth set of data, the fifth set of data, the sixth set of data and the seventh set of data. In an example, the occupancy prediction system 220 uses the historical data associated with the facility 105 to analyze a pattern of the occupancy of the facility 105 during a certain period. In an embodiment of the present disclosure, the period includes a month, a year or a week. The pattern drawn from the first set of data, the second set of data, the third set of data, the fourth set of data, the fifth set of data, the sixth set of data and the seventh set of data facilitates the prediction of the occupancy of the facility 105. In an embodiment of the present disclosure, the booking data collected during the plurality of past seasons facilitates in predicting the occupancy of the facility 105 in upcoming seasons. In an example, the number of bookings done in the past rainy seasons facilitates in predicting the occupancy or booking of the facility 105 in the next rainy seasons. In another example, the occupancy at the time of a sports event organized near the location of the facility 105 facilitates in predicting the occupancy of the facility 105 at the time of next sports event. In yet another example, the feedback gathered from the one or more users 205 for the facility 105 facilitates in predicting the occupancy of the facility 105.

The occupancy prediction system 220 predicts the occupancy of the facility 105 for the particular time interval. In addition, the particular time interval includes specific days, specific dates, specific time, weeks, months, years and festivals. Further, the occupancy of the facility 105 at the particular time interval is predicted based on a request received by the administrator 230. In an example, the request may include prediction of the occupancy of the facility 105 on a coming festival.

In an embodiment of the present disclosure, the third set of data includes current booking data of the facility 105. The current booking data of the facility 105 includes booking requests for the one or more rooms of the facility 105, booking done through the one or more applications associated with the facility 105, booking done through the one or more websites associated with the facility 105 and the like. The occupancy prediction system 220 obtains the current booking data in real-time. In an embodiment of the present disclosure, the current booking data is obtained from the receptionist or the administrator 230 associated with the facility 105. In another embodiment of the present disclosure, the current booking data is obtained from the plurality of sources associated with the facility 105. The occupancy prediction system 220 utilizes the current booking data to predict the occupancy of the facility 105.

In an embodiment of the present disclosure, the occupancy prediction system 220 predicts the occupancy of the facility 105 based on Average Daily Rate (hereinafter, ADR) of the facility 105. In general, the ADR is a metric widely used in hospitality industry to indicate the average realized room rental per day. In an embodiment of the present disclosure, the occupancy prediction system 220 predicts the occupancy of the facility 105 based on Average Room Rate (hereinafter, ARR) of the facility 105. In general, the ARR is a metric widely used in the hospitality industry to measure the average rate per available room. In an embodiment of the present disclosure, the occupancy prediction system 220 predicts the occupancy of the facility 105 based on Revenue per Available Room (hereinafter, RevPAR) of the facility 105. In general, the RevPAR is a performance metric widely used in the hospitality industry that is calculated by multiplication of the ADR and the occupancy of the hotel. In an embodiment of the present disclosure, the occupancy of the facility 105 is predicted based on performance metrics such as ADR, ARR, RevPAR and the like.

In an embodiment of the present disclosure, the occupancy prediction system 220 collects an eighth set of data associated with external factors affecting the facility 105. The external factors affecting the facility 105 includes social factors, legal factors, economic factors, political factors, technological factors, ethical factors and the like. In an example, the social factors include factors such as behavior and beliefs of consumers, households and communities and the like. In an example, the legal factors include factors such as the way in which legislation affects business and the like. In an example, the economic factors include factors such as taxation, government spending, general demand, interest rates, exchange rates, global economic factors and the like. In an example, the political factors include factors such as changes in government policies that impacts business and the like. In an example, the technological factors include factors such as changes in production process, production innovations that impact businesses and the like. In an example, the ethical factors include factors such as right or wrong measures a business may do that impacts users morally and the like. The eighth set of data is data that is affected based on the external factors happening around the facility 105 in the real-time. In an example, the eighth set of data includes natural calamities affecting nearby location of the facility 105, events taking place around the location of the facility 105, and the like.

In an embodiment of the present disclosure, the occupancy prediction system 220 predicts the occupancy of the facility 105 based on the eighth set of data. The occupancy prediction system 220 uses the first set of data, the second set of data, the third set of data, the fourth set of data, the fifth set of data, the sixth set of data, the seventh set of data and the eighth set of data to predict the occupancy of the facility 105. In an example, geographical location of the facility 105 is impacted by a natural calamity such as earthquake, flood and the like. The occupancy prediction system 220 predicts lesser occupancy of the facility 105 in such case. In another example, the geographical location of the facility 105 is impacted by strike. The occupancy prediction system 220 predicts lesser occupancy of the facility 105 in such case. In yet another example, there is a political event benefitting users happening in the nearby geographical location of the facility 105. The occupancy prediction system 220 predicts higher occupancy of the facility 105 in this case. In an embodiment of the present disclosure, the occupancy prediction system 220 predicts the occupancy of the facility 105 based on the machine learning algorithms over the eighth set of data.

The occupancy prediction system 220 is associated with the server 225. In an embodiment of the present disclosure, the occupancy prediction system 220 is located in the server 225. In an embodiment of the present disclosure, the server 225 is a cloud server. The server 225 handles each operation and task performed by the occupancy prediction system 220. The server 225 stores one or more instructions for performing the various operations of the occupancy prediction system 220. In addition, the server 225 stores the first set of data, the second set of data, the third set of data, the fourth set of data, the fifth set of data, the sixth set of data and the seventh set of data. Further, the occupancy prediction system 220 updates the first set of data, the second set of data, the third set of data, the fourth set of data, the fifth set of data, the sixth set of data and the seventh set of data in real time. The occupancy prediction system 220 is associated with the administrator 230. The administrator 230 is any person or individual who monitors the working of the occupancy prediction system 220 in real time. In an embodiment of the present disclosure, the administrator 230 monitors the working of the occupancy prediction system 220 through the portable communication device. The portable communication device includes a laptop, a desktop computer, a tablet, a personal digital assistant and the like.

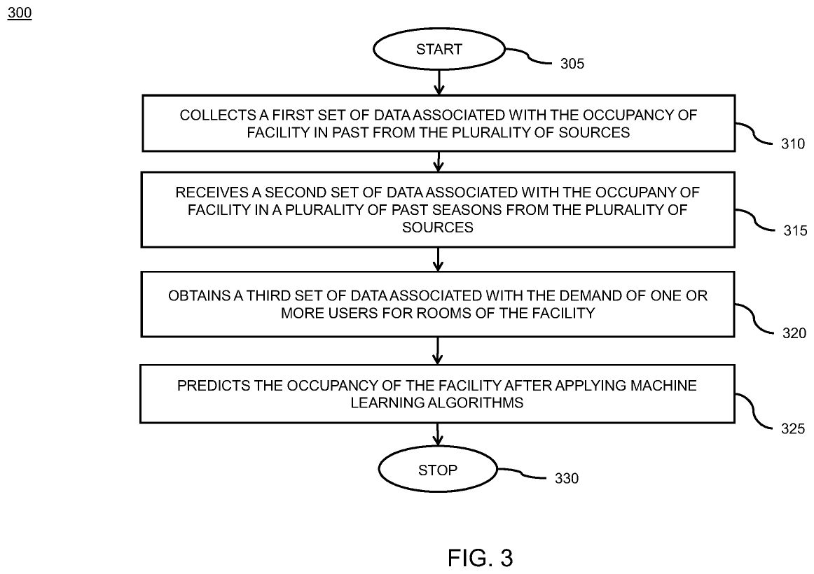

FIG. 3 illustrates a flow chart 300 of the method for predicting the occupancy of the facility 105, in accordance with various embodiments of the present disclosure. It may be noted that in order to explain the method steps of the flowchart 300, references will be made to the elements explained in FIG. 2. The flow chart 300 starts at step 305. At step 310, the occupancy prediction system 220 collects the first set of data associated with the occupancy of the facility 105 in the past from the plurality of sources. At step 315, the occupancy prediction system 220 receives the second set of data associated with the occupancy of the facility 105 in the plurality of past seasons from the plurality of sources. At step 320, the occupancy prediction system 220 obtains the third set of data associated with the demand of one or more users 205 for the plurality of rooms 105a-105h of the facility 105 from the plurality of sources. At step 325, the occupancy prediction system 220 predicts the occupancy of the facility 105 after applying the machine learning algorithms over the first set of data, the second set of data and the third set of data. The flow chart 300 terminates at step 330. It may be noted that the flowchart 300 is explained to have above stated process steps; however, those skilled in the art would appreciate that the flowchart 300 may have more/less number of process steps which may enable all the above stated embodiments of the present disclosure.

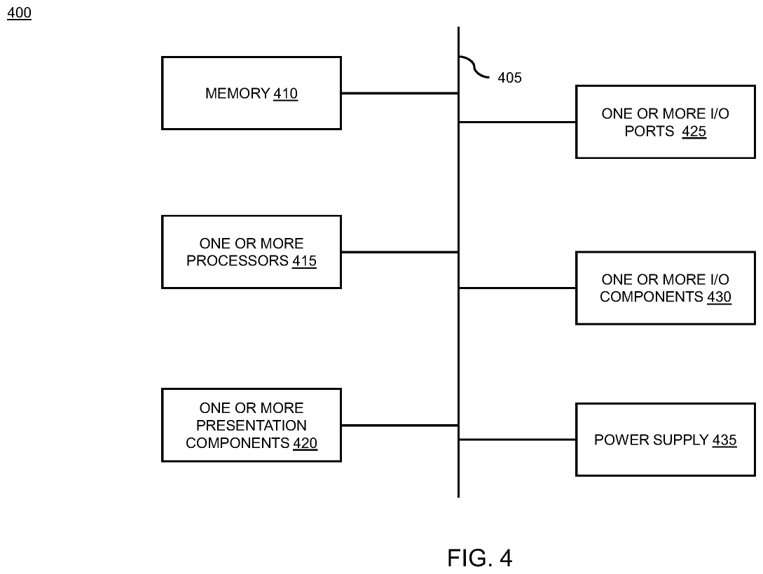

FIG. 4 illustrates a block diagram of a computing device 400, in accordance with various embodiments of the present disclosure. The computing device 400 hosts the occupancy prediction system 220. The computing device 400 includes a bus 405 that directly or indirectly couples the following devices: memory 410, one or more processors 415, one or more presentation components 420, one or more input/output (I/O) ports 425, one or more input/output components 430, and an illustrative power supply 435. The bus 405 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer readable storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 400. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of the computer-readable media. The computing device 400 includes the one or more processors 415 that read data from various entities such as the memory 410 or I/O components 430. The one or more presentation components 420 present data indications to a user or other device. Exemplary presentation components include a display device, speaker, printing component, vibrating component, etc. The one or more I/O ports 425 allow the computing device 400 to be logically coupled to other devices including the one or more I/O components 430, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for predicting the occupancy of a facility, the computer-implemented method comprising:
collecting, at an occupancy prediction system with a processor, a first set of data associated with the occupancy of the facility in past, wherein the first set of data is collected from a plurality of sources;
receiving, at the occupancy prediction system with the processor, a second set of data associated with the occupancy of the facility in a plurality of past seasons, wherein the second set of data is collected from the plurality of sources;
obtaining, at the occupancy prediction system with the processor, a third set of data associated with the demand of one or more users for rooms of the facility, wherein the third set of data corresponds to a clickstream data obtained from the plurality of sources; and
predicting, at the occupancy prediction system with the processor, the occupancy of the facility after applying machine learning algorithms over the first set of data, the second set of data and the third set of data, wherein the occupancy of the facility is predicted in real-time for a particular time interval.

2. The computer-implemented method as recited in claim 1, further comprising gathering, at the occupancy prediction system with the processor, a fourth set of data associated with scheduled events in the nearby areas to the facility.

3. The computer-implemented method as recited in claim 1, further comprising gathering, at the occupancy prediction system with the processor, a fifth set of data associated with nearby facility competitors.

4. The computer-implemented method as recited in claim 1, further comprising gathering, at the occupancy prediction system with the processor, a sixth set of data associated with feedback of the one or more users.

5. The computer-implemented method as recited in claim 1, further comprising gathering, at the occupancy prediction system with the processor, a seventh set of data associated with booking of the facility through coupons and offers, wherein the fourth set of data, the fifth set of data, the sixth set of data and the seventh set of data are analyzed through the machine learning algorithms to predict the occupancy of the facility.

6. The computer-implemented method as recited in claim 1, wherein the first set of data comprises past booking data, past occupancy data and the past booking details of the one or more users.

7. The computer-implemented method as recited in claim 1, wherein the second set of data comprises past booking data received during summers, winters, vacations, weekends, festivals, rainy season.

8. The computer-implemented method as recited in claim 1, wherein the plurality of sources includes one or more web-based platforms associated with the facility, one or more websites associated with the facility, one or more applications associated with the facility and stored past booking database associated with the facility.

9. The computer-implemented method as recited in claim 1, wherein the particular time interval includes specific days, specific date, specific time, weeks, months, years and specific festivals, wherein the occupancy of the facility at the particular time interval is predicted after a request for the prediction is sent to an administrator.

10. The computer-implemented method as recited in claim 1, further comprising updating, at the occupancy prediction system with the processor, the first set of data, the second set of data and the third set of data, wherein the updating is done in real time.

11. A computer system comprising:
one or more processors; and
a memory coupled to the one or more processors, the memory for storing instructions which, when executed by the one or more processors, cause the one or more processors to perform a method for predicting the occupancy of a facility, the method comprising:
collecting, at an occupancy prediction system, a first set of data associated with the occupancy of the facility in past, wherein the first set of data is collected from a plurality of sources;
receiving, at the occupancy prediction system, a second set of data associated with the occupancy of the facility in a plurality of past seasons, wherein the second set of data is collected from the plurality of sources;
obtaining, at the occupancy prediction system, a third set of data associated with the demand of one or more users for rooms of the facility, wherein the third set of data corresponds to a clickstream data obtained from the plurality of sources; and
predicting, at the occupancy prediction system, the occupancy of the facility after applying machine learning algorithms over the first set of data, the second set of data and the third set of data, wherein the occupancy of the facility is predicted in real-time for a particular time interval.

12. The computer system as recited in claim 1, further comprising gathering, at the occupancy prediction system, a fourth set of data associated with scheduled events in the nearby areas to the facility, a fifth set of data associated with nearby facility competitors, a sixth set of data associated with feedback of the one or more users, and a seventh set of data associated with booking of the facility through coupons and offers, wherein the fourth set of data, the fifth set of data, the sixth set of data and the seventh set of data are analyzed through the machine learning algorithms to predict the occupancy of the facility.

13. The computer system as recited in claim 1, wherein the first set of data comprises past booking data, past occupancy data and the past booking details of the one or more users.

14. The computer system as recited in claim 1, wherein the second set of data comprises past booking data received during summers, winters, vacations, weekends, festivals, rainy season.

15. The computer system as recited in claim 1, wherein the plurality of sources includes one or more web-based platforms associated with the facility, one or more websites associated with the facility, one or more applications associated with the facility and stored past booking database associated with the facility.

16. The computer system as recited in claim 1, wherein the particular time interval includes specific days, specific date, specific time, weeks, months, years and specific festivals, wherein the occupancy of the facility at the particular time interval is predicted after a request for the prediction is sent to an administrator.

17. The computer system as recited in claim 1, further comprising updating, at the occupancy prediction system, the first set of data, the second set of data and the third set of data, wherein the updating is done in real time.

18. A non-transitory computer-readable storage medium encoding computer executable instructions that, when executed by at least one processor, performs a method for predicting the occupancy of a facility, the method comprising:
collecting, at a computing device, a first set of data associated with the occupancy of the facility in past, wherein the first set of data is collected from a plurality of sources;
receiving, at the computing device, a second set of data associated with the occupancy of the facility in a plurality of past seasons, wherein the second set of data is collected from the plurality of sources;
obtaining, at the computing device, a third set of data associated with the demand of one or more users for rooms of the facility, wherein the third set of data corresponds to a clickstream data obtained from the plurality of sources; and
predicting, at the computing device, the occupancy of the facility after applying machine learning algorithms over the first set of data, the second set of data and the third set of data, wherein the occupancy of the facility is predicted in real-time for a particular time interval.

19. The non-transitory computer-readable storage medium as recited in claim 18, wherein the first set of data comprises past booking data, past occupancy data and the past booking details of the one or more users.

20. The non-transitory computer-readable storage medium as recited in claim 18, wherein the second set of data comprises past booking data received during summers, winters, vacations, weekends, festivals, rainy season.
